(19) United States
(12) Patent Application Publication
(10) Pub. No.: US 2021/0230347 A1
(43) Pub. Date: Jul. 29, 2021

(54) METHOD FOR PRODUCING A POLYURETHANE DISPERSION WITH A REDUCED FOAM FORMATION

(71) Applicant: Covestro Intellectual Property GmbH & Co. KG, Leverkusen (DE)

(72) Inventors: Sebastian Doerr, Düsseldorf (DE); Martin Brahm, Odenthal (DE); Alfred Zastrow, Dormagen (DE)

(21) Appl. No.: 16/972,125

(22) PCT Filed: Jul. 2, 2019
(86) PCT No.: PCT/EP2019/067657

§ 371 Date: Dec. 4, 2020

(30) Foreign Application Priority Data
Jul. 3, 2018 (EP) 18181427.8

(51) Int. Cl. C08G 18/48; C08G 18/75; C08G 18/42; C08G 18/40; C08G 18/32; C08G 18/12; C08G 18/08

(52) U.S. Cl. CPC C08G 18/485; C08G 18/755; C08G 18/4238; C08G 18/0866; C08G 18/3234; C08G 18/12; C08G 18/4018

(57) ABSTRACT

The invention relates to a method for producing a polyurethane dispersion, having the steps of: I) providing isocyanate-functional prepolymers A) in a liquid phase comprising a solvent which can be mixed with water and which has a lower boiling point than water and II) adding NCO-reactive compounds to the isocyanate-functional prepolymers from step I) such that a reaction with the prepolymers is at least partly produced; wherein the liquid phase in step I) additionally comprises water and/or after step II), water is added to the mixture obtained in step II). A pressure p1 is applied to the liquid mixture with the isocyanate-functional prepolymers A) prior to and/or while carrying out step II), wherein p1 is less than the local atmospheric pressure present at said point in time. The pressure p1 is selected such that in step II), ≤50 mass. % (preferably >0 mass. % to ≤mass. %, more preferably ≥0.1 mass. % to ≤30 mass. % in particular ≥1 mass. % to ≤10 mass. %) of the originally provided solvent which can be mixed with water is distilled.

The present invention relates to a process for producing a polyurethane dispersion, comprising the steps of: I) providing isocyanate-functional prepolymers A) in a liquid phase comprising a solvent which is miscible with water and has a lower boiling point than water and II) adding NCO-reactive compounds to the isocyanate-functional prepolymers from step I), such that at least partial reaction with the prepolymers occurs; where the liquid phase in step I) still comprises water and/or, after step II), water is added to the mixture obtained after step II). In the production of low-solvent polyurethane dispersions by the acetone process, the polymer is at first present dissolved in acetone and is then dispersed in water. Subsequently, the acetone is removed by distillation under reduced pressure. Large amounts of foam often arise here, which means that the distillation rate has to be distinctly reduced. This lowers the space-time yield of the plant. The addition of defoamers, the chemical basis of which is frequently hydrophobic mineral oils or silicone oils, can only partly suppress foam formation. Furthermore, the presence of defoamers is undesirable in many products. For example, defoamers can result in leveling defects in paints.

DE 27 08 442 A1 relates to a process for producing modified aqueous polymer dispersions, wherein room temperature liquid organic diisocyanates are introduced into non-sedimented, aqueous polymer dispersions containing polyurethanes, optionally in the simultaneous presence of catalysts that accelerate isocyanate polyaddition reactions and/or dimerization of isocyanate groups and/or carbodiimidization of isocyanate groups and/or trimerization of isocyanate groups, while mixing at such a temperature where there is no visible foam formation, the temperature conditions mentioned are maintained on completion of addition of the diisocyanate until at least 50% of isocyanate groups of the diisocyanate introduced have reacted and the conversion is optionally subsequently conducted to completion by heating to temperatures up to 100° C.

It is an object of the present invention to provide a process for production of a polyurethane dispersion, in which lower foam formation occurs during the distillative removal of organic solvents.

This object is achieved by a process as claimed in claim 1. Advantageous developments are specified in the dependent claims. They may be freely combined unless the opposite is clear from the context.

A process for producing a polyurethane dispersion comprises the steps of:

I) providing isocyanate-functional prepolymers A) in a liquid phase comprising a solvent which is miscible with water and has a lower boiling point than water;

II) adding NCO-reactive compounds to the isocyanate-functional prepolymers from step I), such that at least partial reaction with the prepolymers occurs;

where the liquid phase in step I) still comprises water and/or, after step II), water is added to the mixture obtained after step II).

Before and/or during the performance of step II), a pressure p1 above the liquid mixture comprising the isocyanate-functional prepolymers A) is applied, where p1 is less than the atmospheric pressure that exists locally at this juncture, and

the pressure p1 is chosen such that, in step II), ≤50% by mass (preferably >0% by mass to ≤40% by mass, more preferably ≥0.1% by mass to ≤30% by mass, further preferably ≥1% by mass to ≤10% by mass) of the water-miscible solvent originally present is distilled off.

It has been found that, surprisingly, foam formation is lower when a conventional process is altered in such a way that the step of chain extension takes place after a vacuum has been applied. This does not yet distill off the entirety of the organic solvent, which can be controlled by suitable values of vacuum and temperature. Reduced foam formation allows the subsequent distillation to be conducted more quickly, such that the yields of the production plants can be increased. It is additionally possible to choose the pressure p1 at least before step II) in such a way that ≤10% by mass (preferably >0% by mass to ≤5% by mass, more preferably ≥0.01% by mass to ≤3% by mass, further preferably ≥0.1% by mass to ≤1% by mass) of the water-miscible solvent originally present per minute is distilled off.

The prepolymer A) may have an average NCO functionality of ≥1.2 to ≤3. For preparation thereof, the polyisocyanate is or the polyisocyanates are used in stoichiometric excess, such that the prepolymer has terminal isocyanate groups.

Particularly suitable solvents for the prepolymer are wholly or partly miscible with water in the temperature range of 20° C.-120° C., have only low reactivity, if any, toward isocyanate groups and may optionally be distilled off after production of the dispersion. It is additionally also possible, in addition to the aforementioned solvents, to use further water-immiscible or sparingly water-miscible solvents have only low reactivity, if any, toward isocyanate groups. Also suitable for production of the dispersions of the invention are solvent mixtures of multiple solvents that meet the aforementioned conditions.

Preferred solvents are acetone, butanone, tetrahydrofuran, ethyl acetate, butyl acetate and/or dimethyl carbonate. Very particular preference is given to acetone.

In a preferred embodiment, the isocyanate-functional prepolymers A) are obtainable from the reaction of

A1) organic polyisocyanates with

A2) monomeric polyols and/or polymeric polyols having number-average molecular weights of ≥400 g/mol to ≤8000 g/mol and OH functionalities of ≥1.5 to ≤6.

Suitable polyisocyanates A1) are aromatic, araliphatic, aliphatic or cycloaliphatic polyisocyanates. It is also possible to use mixtures of such polyisocyanates. Preferred polyisocyanates are selected from the group consisting of butylene diisocyanate, hexamethylene diisocyanate (HDI), pentamethylene 1,5-diisocyanate, isophorone diisocyanate (IPDI), 2,2,4- and/or 2,4,4-trimethylhexamethylene diisocyanate, the isomeric bis(4,4′-isocyanatocyclohexyl)methanes or mixtures thereof with any isomer content, isocyanatomethyloctane 1,8-diisocyanate, cyclohexylene 1,4-diisocyanate, phenylene 1,4-diisocyanate, tolylene 2,4- and/or 2,6-diisocyanate, naphthylene 1,5-diisocyanate, diphenylmethane 2,4′- or 4,4′-diisocyanate, triphenylmethane 4,4′,4″-triisocyanate and derivatives thereof having urethane, isocyanurate, allophanate, biuret, uretdione, iminooxadiazinedione structure. Also preferred are mixtures thereof. Particular preference is given to hexamethylene diisocyanate, isophorone diisocyanate and the isomeric bis(4,4′-isocyanatocyclohexyl)methanes, and mixtures thereof.

Suitable monomeric polyols A2) are, for example, short-chain aliphatic, araliphatic or cycloaliphatic polyols, i.e. those containing 2 to 20 carbon atoms. Examples of diols are ethylene glycol, diethylene glycol, triethylene glycol, tetraethylene glycol, dipropylene glycol, tripropylene glycol, propane-1,2-diol, propane-1,3-diol, butane-1,4-diol, neopentyl glycol, 2-ethyl-2-butylpropanediol, trimethylpentanediol, positionally isomeric diethyloctanediols, 1,3-butylene glycol, cyclohexanediol, cyclohexane-1,4-dimethanol, hexane-1,6-diol, cyclohexane-1,2- and -1,4-diol, hydrogenated bisphenol A (2,2-bis(4-hydroxycyclohexyl)propane), 2,2-dimethyl-3-hydroxypropyl 2,2-dimethyl-3-hydroxypropionate. Preference is given to butane-1,4-diol, cyclohexane-1,4-dimethanol and hexane-1,6-diol. Examples of suitable triols are trimethylolethane, trimethylolpropane or glycerol, preference being given to trimethylolpropane.

The polymeric polyols A2) are compounds formed in turn from monomers and, in addition to the usually terminal isocyanate-reactive end groups, having further functional groups along the main chain

Suitable higher molecular weight polyols are polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols, polyether polyamines and polyamido polyamines; particular preference is given to polyester polyols, polyether polyols and polycarbonate polyols; particular preference is given to polyester polyols.

The suitable polyester polyols are frequently formed from one or more aliphatic and/or aromatic and/or araliphatic dicarboxylic acids with one or more aliphatic and/or aromatic and/or araliphatic diols and are prepared via a polycondensation process.

Polyester polyols of good suitability are the known polycondensates of di- and optionally tri- and tetraols and di- and optionally tri- and tetra)carboxylic acids or hydroxycarboxylic acids or lactones. Instead of the free polycarboxylic acids, it is also possible to use the corresponding polycarboxylic anhydrides or corresponding polycarboxylic esters of lower alcohols for preparing the polyesters. Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate, preference being given to the three latter compounds. In order to achieve a functionality ≥2, it is possible to use proportions of polyols having a functionality of 3, examples of which include trimethylolpropane, glycerol, erythritol, pentaerythritol, trimethylolbenzene or trishydroxyethyl isocyanurate.

Preferred dicarboxylic acids are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, succinic acid, 3,3-diethylglutaric acid, 2,2-dimethylsuccinic acid. Anhydrides of these acids are likewise usable, where they exist. For the purposes of the present invention, the anhydrides are consequently covered by the expression “acid”. Preference is also given to using monocarboxylic acids such as benzoic acid and hexanecarboxylic acid, provided that the mean functionality of the polyol is ≥2. Saturated aliphatic or aromatic acids are preferred, such as adipic acid or isophthalic acid. One example of a polycarboxylic acid for optional additional use in smaller amounts here is trimellitic acid.

Examples of hydroxycarboxylic acids suitable as co-reactants in the preparation of a polyester polyol having terminal hydroxyl groups include hydroxycaproic acid, hydroxybutyric acid, hydroxydecanoic acid, hydroxystearic acid and the like. Usable lactones include ε-caprolactone, butyrolactone and homologs.

Preference is given to polyester polyols based on butanediol and/or neopentyl glycol and/or hexanediol and/or ethylene glycol and/or diethylene glycol with adipic acid and/or phthalic acid and/or isophthalic acid. Particular preference is given to polyester polyols based on butanediol and/or neopentyl glycol and/or hexanediol with adipic acid and/or phthalic acid.

Polyether polyols include, for example, the polyaddition products of the styrene oxides, of ethylene oxide, propylene oxide, tetrahydrofuran, butylene oxide, epichlorohydrin, and the mixed addition and grafting products thereof, and the polyether polyols obtained by condensation of polyhydric alcohols or mixtures thereof and those obtained by alkoxylation of polyhydric alcohols, amines and amino alcohols.

Suitable hydroxy-functional polyethers have OH functionalities of 1.5 to 6.0, preferably 1.8 to 3.0, OH numbers of 50 to 700 and preferably of 100 to 600 mg KOH/g of solids, and molecular weights Mn of 106 to 4000 g/mol, preferably of 200 to 3500, for example alkoxylation products of hydroxy-functional starter molecules such as ethylene glycol, propylene glycol, butanediol, hexanediol, trimethylolpropane, glycerol, pentaerythritol, sorbitol or mixtures of these and also other hydroxy-functional compounds with propylene oxide or butylene oxide. Preference is given to polypropylene oxide polyols and polytetramethylene oxide polyols having a molecular weight of 300 to 4000 g/mol. In this context, the polyether polyols of particularly low molecular weight, given correspondingly high OH contents, may be water-soluble. Particular preference is given however to water-insoluble polypropylene oxide polyols and polytetramethylene oxide polyols having a molecular weight of 500-3000 g/mol and mixtures thereof.

The useful polycarbonate polyols are obtainable by reaction of carbonic acid derivatives, for example diphenyl carbonate, dimethyl carbonate or phosgene, with diols. Useful diols of this kind include, for example, ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, tetrabromobisphenol A, but also lactone-modified diols. Preferably, the diol component contains 40% to 100% by weight of hexane-1,6-diol and/or hexanediol derivatives, preferably those having not only terminal OH groups but also ether or ester groups, for example products which are obtained by reaction of 1 mol of hexanediol with at least 1 mol, preferably 1 to 2 mol, of ε-caprolactone, or by etherification of hexanediol with itself to give di- or trihexylene glycol. It is also possible to use polyether polycarbonate polyols.

Preference is given to polycarbonate polyols based on dimethyl carbonate and hexanediol and/or butanediol and/or ε-caprolactone. Very particular preference is given to polycarbonate polyols based on dimethyl carbonate and hexanediol and/or ε-caprolactone. It is also possible that, in the synthesis of the prepolymers, isocyanate-reactive cationic, potentially cationic, anionic or potentially anionic and/or nonionic hydrophilizing agents A4) are added directly. Details of the hydrophilizing agents A4) are given further down in the text.

In a further preferred embodiment, in step II), isocyanate-reactive compounds A3) having molecular weights of 62 to 399 g/mol are added. The degree of chain extension, i.e. the equivalents ratio of NCO-reactive groups of the compounds used for chain extension and chain termination to free NCO groups of the prepolymer, is generally between 40% and 150%, preferably between 50% and 110%, more preferably between 60% and 100%. Chain extension of the prepolymers with compounds A3) can be accomplished, for example, using amines having no ionic or ionogenic groups, such as anionically hydrophilizing groups. Preference is given to using, as component A3), organic di- or polyamines such as for example ethylene-1,2-diamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 4,4-diaminodicyclohexylmethane, hydrazine hydrate and/or dimethylethylenediamine.

In addition, components A3) used may also be compounds that have not only a primary amino group but also secondary amino groups, or not only an amino group (primary or secondary) but also OH groups. Examples thereof are primary/secondary amines such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine.

Furthermore, components A3) used may also be monofunctional isocyanate-reactive amine compounds, for example methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amide amines formed from diprimary amines and monocarboxylic acids, monoketime of diprimary amines, primary/tertiary amines, such as N,N-dimethylaminopropylamine.

Suitable components A3) are also dihydrazides, for example adipic dihydrazide, oxalic dihydrazide, carbohydrazide, and succinic dihydrazide. Likewise useful as component A3) are longer-chain amino-functional compounds such as polyetheramines (“Jeffamines”).

Components A3) used are preferably ethylene-1,2-diamine, bis(4-aminocyclohexyl)methane, 1,4-diaminobutane, isophoronediamine, ethanolamine, diethanolamine and diethylenetriamine.

Chain extension of the prepolymers with compounds A3) can also be accomplished using low molecular weight polyols, for example. Suitable low molecular weight polyols are short-chain aliphatic, araliphatic or cycloaliphatic compounds, i.e. those containing 2 to 20 carbon atoms. Examples of diols are ethylene glycol, diethylene glycol, triethylene glycol, tetraethylene glycol, dipropylene glycol, tripropylene glycol, propane-1,2-diol, propane-1,3-diol, butane-1,4-diol, neopentyl glycol, 2-ethyl-2-butylpropanediol, trimethylpentanediol, positionally isomeric diethyloctanediols, 1,3-butylene glycol, cyclohexanediol, cyclohexane-1,4-dimethanol, hexane-1,6-diol, cyclohexane-1,2- and -1,4-diol, hydrogenated bisphenol A (2,2-bis(4-hydroxycyclohexyl)propane), 2,2-dimethyl-3-hydroxypropyl 2,2-dimethyl-3-hydroxypropionate. Preference is given to butane-1,4-diol, cyclohexane-1,4-dimethanol and hexane-1,6-diol. Examples of suitable triols are trimethylolethane, trimethylolpropane or glycerol, preference being given to trimethylolpropane.

Further examples of chain extenders A3) are dihydrazides such as oxalic dihydrazide, carbohydrazide and adipic dihydrazide, particular preference being given to carbohydrazide and adipic dihydrazide. Examples of suitable dithiols are ethane-1,2-dithiol, propane-1,3-dithiol, butane-1,4-dithiol and hexane-1,6-dithiol. Particular preference is given to ethane-1,2-dithiol and hexane-1,6-dithiol.

Low molecular weight compounds A3) used are preferably diamines. In general, alcohol-functional compounds are preferably incorporated into the prepolymer via the components A2). Units having isocyanate-reactive amino groups (primary or secondary amines) are preferably incorporated by reaction as component A3). If a unit contains both isocyanate-reactive amino groups and alcohol groups, it is preferably incorporated via component A3).

In a further preferred embodiment, step II) isocyanate-reactive cationic, potentially cationic, anionic or potentially anionic and/or nonionic hydrophilizing agents A4) are added. The degree of chain extension, i.e. the equivalents ratio of NCO-reactive groups of the compounds used for chain extension and chain termination to free NCO groups of the prepolymer, is generally between 40% and 150%, preferably between 50% and 110%, more preferably between 60% and 100%.

Dispersing compounds (hydrophilizing agents) A4) are those that contain, for example, sulfonium, ammonium, phosphonium, carboxylate, sulfonate or phosphonate groups or groups which can be converted by salt formation to the aforementioned groups (potentially ionic groups), or polyether groups, and can be incorporated into the macromolecules via isocyanate-reactive groups present. The neutralizing agents required for salt formation may be added either stoichiometrically or in deficiency relative to the salt-forming group. Anionic groups are generated by adding organic bases, such as tertiary amines, or inorganic bases, such as alkali metal hydroxides or ammonia. Preference is given here to using tertiary amines such as triethylamine, triethanolamine or dimethylethanolamine Preferred suitable isocyanate-reactive groups are hydroxyl and amino groups.

Suitable ionic or potentially ionic compounds are, for example, mono- and dihydroxycarboxylic acids, mono- and diaminocarboxylic acids, mono- and dihydroxysulfonic acids, mono- and diaminosulfonic acids and mono- and dihydroxyphosphonic acids or mono- and diaminophosphonic acids and salts thereof, such as dimethylolpropionic acid, dimethylolbutyric acid, hydroxypivalic acid, N-(2-aminoethyl)alanine, 2-(2-aminoethylamino)ethanesulfonic acid, ethylenediaminepropyl- or -butylsulfonic acid, propylene-1,2- or -1,3-diamineethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, example 1) and the alkali metal and/or ammonium salts thereof; the adduct of sodium bisulfite onto but-2-ene-1,4-diol, polyethersulfonate, the propoxylated adduct of 2-butenediol and NaHSO₃, described, for example, in DE-A 2 446 440 (pages 5-9, formulae and units that can be converted to cationic groups, such as N-methyldiethanolamine, as hydrophilic formation components. Furthermore, the salt of cyclohexaminopropanesulfonic acid (CAPS) from WO-A 01/88006 can be used as an anionic hydrophilizing agent. Preferred ionic or potential ionic compounds are those having carboxyl or carboxylate and/or sulfonate groups and/or ammonium groups.

Preferred compounds are polyether sulfonate, dimethylolpropionic acid, tartaric acid and dimethylolbutyric acid, particular preference being given to polyether sulfonate and dimethylolpropionic acid.

Suitable nonionically hydrophilizing compounds are, for example, polyoxyalkylene ethers containing at least one hydroxyl or amino group. These polyethers contain a proportion of 30% by weight to 100% by weight of units derived from ethylene oxide. Useful compounds include polyethers of linear construction having a functionality between 1 and 3, but also compounds of the general formula:

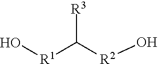

in which R1 and R2 are each independently a divalent aliphatic, cycloaliphatic or aromatic radical which has 1 to 18 carbon atoms and may be interrupted by oxygen and/or nitrogen atoms, and R3 is an alkoxy-terminated polyethylene oxide radical.

Nonionic hydrophilizing compounds are, for example, also monovalent polyalkylene oxide polyether alcohols having a statistical average of 5 to 70, preferably 7 to 55, ethylene oxide units per molecule, as obtainable in a manner known per se by alkoxylation of suitable starter molecules.

Suitable starter molecules are, for example, saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or olein alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine, and heterocyclic secondary amines such as morpholine, pyrrolidine, piperidine or 1H-pyrazole. Preferred starter molecules are saturated monoalcohols. Particular preference is given to using diethylene glycol monobutyl ether as starter molecule.

Alkylene oxides suitable for the alkoxylation reaction are especially ethylene oxide and propylene oxide, which can be used in the alkoxylation reaction in any sequence or else in a mixture.

The polyalkylene oxide polyether alcohols are either pure polyethylene oxide polyethers or mixed polyalkylene oxide polyethers whose alkylene oxide units consist to an extent of at least 30 mol %, preferably to an extent of at least 40 mol %, of ethylene oxide units. Preferred nonionic compounds are monofunctional mixed polyalkylene oxide polyethers having at least 40 mol % of ethylene oxide units and not more than 60 mol % of propylene oxide units.

Particular preference is given to monohydroxy-functional alkoxypolyethylene glycols such as MPEG 750 (Dow Chemical) and LB 25 (Bayer) and dihydroxy-functional compounds having lateral polyethylene oxide units such as Ymer N 120 (Perstorp) or Tegomer D 3404.

A particularly preferred prepolymer is prepared from a polyester formed from adipic acid, hexane-1,6-diol and neopentyl glycol, and hexamethylene diisocyanate. The polyester preferably has a molar mass of 1700 g/mol.

A particularly preferred chain extension reagent is 2-(2-aminoethylamino)ethanesulfonic acid.

The molar ratio for the preparation of the prepolymer A) of NCO groups to isocyanate-reactive groups may vary here from 1.05-4.00, preferably from 1.2-3.0, more preferably from 1.4-2.5. The prepolymers are prepared by initially charging a reaction vessel with the appropriate polyol or a mixture of different polyols and subsequently adding the polyisocyanate or the mixture of polyisocyanates at elevated temperature. If mixtures of polyols and/or polyisocyanates are used, the individual co-reactants may then also be added at different junctures in order to achieve controlled formation of the prepolymer. The reaction here can be effected either in the melt or else in suitable, inert solvents, for example acetone or butanone. The reaction temperature here is between 50° C. and 130° C. and the reaction time is 1 h-24 h. The urethanization reaction may be accelerated by using suitable catalysts. Suitable for this purpose are the catalysts known to those skilled in the art such as triethylamine, 1,4-diazabicyclo-[2.2.2]-octane, tin dioctoate, dibutyltin dilaurate or bismuth dioctoate, which are initially charged or metered in at a later stage. Preference is given to dibutyltin dilaurate. The reaction has typically ended when there is no further change in the NCO content; the reaction is typically monitored by titration. In order to ensure the further processing of the prepolymer, low-viscosity prepolymers are generally advantageous, for which purpose, if not done during the preparation, the prepolymer is dissolved in a suitable solvent. Low-viscosity prepolymers or prepolymer solutions refer to those systems having viscosity of <104 mPas at a shear rate of 40 s−1. The prepolymer solution in this case preferably has a solids content of >40% and acetone is preferably used as solvent.

A preferred polyurethane dispersion to be prepared by the process of the invention contains 9% to 60% by weight of a polyisocyanate compound, 35% to 90% by weight of an isocyanate-reactive polyol having a molar mass of >500 g/mol, 0.5% to 5% by weight of an ionic or potentially ionic hydrophilizing agent and 0.5% to 10% by weight of a chain extender amine having no hydrophilic groups.

In a particularly preferred embodiment, the polyurethane dispersion contains at least one additive selected from the group consisting of 0.1% to 25.0% by weight of a nonionic hydrophilizing agent, 0.1 to 15.0% by weight of a further polyol having a molar mass of ≤500 g/mol, and 0.1% to 3.0% by weight of further auxiliaries or additives, especially emulsifiers, biocides, aging stabilizers.

In a further preferred embodiment, step II) comprises the adding of amino-functional anionic, potentially anionic and/or nonionic hydrophilizing agents to the isocyanate-functional prepolymers from step I).

In a further preferred embodiment, a pressure p2 (the atmospheric pressure that exists locally at this juncture is applied after step II), such that ≥95% by mass of the water-miscible solvent originally present is distilled off and an aqueous polyurethane dispersion is obtained.

In a further preferred embodiment, the process is performed in such a way that defoamers are present in the resultant polyurethane dispersion in a proportion of ≤1% by weight, based on the weight of the polyurethane. Such defoamers may, for example, be mineral oils or silicone oils. Preference is given to the absence of defoamers, although technically unavoidable impurities shall be included in the term “absence”.

In a further preferred embodiment, the pressure p1 is ≥10 mbar to ≤800 mbar. Preferred pressures for p1 are ≥100 mbar to ≤700 mbar, more preferably ≥300 mbar to ≤600 mbar.

In a further preferred embodiment, the pressure p2 is ≥20 mbar to ≤600 mbar. Preferred pressures for p2 are ≥50 mbar to ≤400 mbar, more preferably ≥80 mbar to ≤200 mbar.

In a further preferred embodiment, a liquid mixture comprising the isocyanate-functional prepolymers A) before and/or during the performance of step II) is at a temperature T of ≥10° C. to ≤70° C. (preferably ≥20° C. to ≤50° C.).

The present invention is elucidated in detail by the examples that follow, but without being limited thereto.

### COMPARATIVE EXAMPLE: ATTEMPTED PREPARATION OF A POLYURETHANEUREA DISPERSION WITH A HIGH TENDENCY TO FOAM

2253.3 g of a polyester formed from adipic acid, hexanediol and neopentyl glycol and having an average molecular weight of 1700 g/mol and 22.0 g of a hydrophilic monofunctional polyether based on ethylene oxide/propylene oxide (number-average molecular weight 2250 g/mol, OH number 25 mg KOH/g) were heated up to 65° C. Subsequently, 54.7 g of isophorone diisocyanate (IPDI) was added and the mixture was stirred at 12° C. until the NCO value had gone below the theoretical value. The finished prepolymer was dissolved with 540 g of acetone at 50° C., and a solution of 13.0 g of isophoronediamine (IPDA) in 95.3 g of water was metered in at 40° C. at atmospheric pressure. The mixture was stirred for a further 15 min. This was followed by dispersion by addition of 2900 g of water—these steps were likewise performed at atmospheric pressure (locally and at the juncture in question about 1000 mbar). The acetone solvent was then deliberately removed by distillation under reduced pressure. As this was done, the mixture foamed so significantly that the experiment was terminated at internal pressure about 500 mbar since the foam reached the buffer vessel installed to safeguard the pump.

### INVENTIVE EXAMPLE: PREPARATION OF A POLYURETHANEUREA DISPERSION WITH SIGNIFICANT TENDENCY TO FOAMING, WITH PERFORMANCE OF THE CHAIN EXTENSION STEP UNDER REDUCED PRESSURE

2253.3 g of a polyester formed from adipic acid, hexanediol and neopentyl glycol, having an average molecular weight of 1700 g/mol, and 22.0 g of a hydrophilic monofunctional polyether based on ethylene oxide/propylene oxide (number-average molecular weight 2250 g/mol, OH number 25 mg KOH/g) were heated up to 65° C. Subsequently, 54.7 g of isophorone diisocyanate (IPDI) was added and the mixture was stirred until the NCO value went below the theoretical value. The finished prepolymer was dissolved with 540 g of acetone at 50° C., and a solution of 13.0 g of isophoronediamine (IPDA) in 95.3 g of water was metered in at 40° C. at internal pressure about 500 mbar. The mixture was stirred for a further 15 min. This was followed by dispersion by addition of 2900 g of water—these steps were likewise performed at about 500 mbar. The solvent was then removed by distillation under reduced pressure down to a pressure of about 120 mbar, and a storage-stable dispersion was obtained. The solids content was adjusted by adding water.

Solids content: 30%; particle size (LCS): 270 nm

Viscosity: <50 mPas

pH: 8.9

1. A process for producing a polyurethane dispersion, comprising:
I) providing isocyanate-functional prepolymers A) in a liquid phase comprising a water-miscible solvent having a lower boiling point than water; and
II) adding NCO-reactive compounds to the isocyanate-functional prepolymers A) to form a mixture, such that at least partial reaction with the isocyanate-functional prepolymers A) occurs,
wherein the liquid phase in step I) comprises water and/or, after step II), water is added to the mixture, and
wherein a pressure p1 is applied above the mixture before and/or during the performance of step II), wherein p1 is less than a local atmospheric pressure, and
wherein the pressure p1 is chosen such that, in step II), ≤50% by mass of the water-miscible solvent originally present is distilled off.

2. The process as claimed in claim 1, wherein the isocyanate-functional prepolymers A) are obtained from a reaction of
A1) organic polyisocyanates with
A2) monomeric polyols and/or polymeric polyols having number-average molecular weights of ≥400 g/mol to ≤8000 g/mol and OH functionalities of ≥1.5 to ≤6.

3. The process as claimed in claim 1, wherein isocyanate-reactive compounds A3) having molecular weights of 62 to 399 g/mol are added in step II).

4. The process as claimed in claim 1, comprising adding hydrophilizing agents A4) in step II), wherein the hydrophilizing agents A4) comprise cationic or potentially cationic hydrophilizing agents, anionic or potentially anionic hydrophilizing agents, nonionic hydrophilizing agents, or a combination thereof.

5. The process as claimed in claim 1, comprising applying a pressure p2 lower than the local atmospheric pressure after step II), such that ≥95% by mass of the water-miscible solvent originally present is distilled off and an aqueous polyurethane dispersion is obtained.

6. The process as claimed in claim 1, wherein the polyurethane dispersion comprises a defoamer in an amount of ≤1% by weight, based on the weight of the polyurethane.

7. The process as claimed in claim 1, wherein the pressure p1 is ≥10 mbar to ≤800 mbar.

8. The process as claimed in claim 5, wherein the pressure p2 is ≥20 mbar to ≤600 mbar.

9. The process as claimed in claim 1, comprising maintaining the mixture at a temperature T, where T is ≥10° C. to ≤70° C. before and/or during the performance of step II).
